(19) United States
(12) Patent Application Publication
(10) Pub. No.: US 2009/0126710 A1
(43) Pub. Date: May 21, 2009

(54) DUAL COIL IGNITION CIRCUIT FOR SPARK IGNITED ENGINE

(75) Inventors: Terrence Francis Alger, II, San Antonio, TX (US); Kane Tyler, San Antonio, TX (US); Barrett Wade Mangold, Atascosa, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Southwest Research Institute, San Antonio, TX (US)

(21) Appl. No.: 11/944,195

(22) Filed: Nov. 21, 2007

(51) Int. Cl. F02P 15/08; F02P 5/00; F02P 3/04

(52) U.S. Cl. 123/636; 123/406.12; 123/634

(57) ABSTRACT

An electrical circuit for extending the duration of the spark provided by a spark plug. Instead of a single coil (and a single pair of windings), a dual coil unit is used. The dual coil unit may be operated in a “multi-strike” mode in which the discharge of each coil is shortened and offset from that of the other coil. This provides an effective spark for an extended duration.

### TECHNICAL FIELD OF THE INVENTION

This invention relates to engine ignition systems, and more particularly to an ignition circuit for providing an extended duration spark at an igniter.

### BACKGROUND OF THE INVENTION

Recent research has shown that increased levels of exhaust gas recirculation (EGR) in spark ignition engines can enable operation at higher compression ratios and loads than were previously possible, due primarily to a reduction in knock tendency. Increasing the amount of dilution by increasing the air/fuel ratio has also been shown to have similar effects.

Implementation of these features gives rise to the problem of ignition and flame propagation at these increased dilution levels. Several companies now sell enhanced ignition circuits and new types of igniters to improve ignitability and promote faster burn rates in the engine. Two examples are “plasma jet” and “railplug” igniters.

Experience has also shown that for very dilute mixtures, a longer duration spark leads to better ignitability. The increased duration of the spark increases the probability of an ignitable mixture moving through the spark gap.

### BRIEF DESCRIPTION OF THE DRAWINGS

FIG. 1 illustrates one embodiment of the dual coil ignition circuit in accordance with the invention.

FIG. 2 illustrates the dual coil unit of FIG. 1 in further detail.

FIG. 3 is a current trace from the primary and secondary sides of one of the coils of FIG. 2.

FIGS. 4A and 4B are current traces of the combined secondary currents (FIG. 4A) and offset primary currents from the two coils (FIG. 4B).

FIG. 5 illustrates the improved burn rates resulting from the dual coil ignition.

FIG. 6 illustrates an alternative embodiment of the dual coil unit.

### DETAILED DESCRIPTION OF THE INVENTION

This description is directed to a dual-coil ignition circuit, which extends the period of time in which a spark is formed at an igniter, such as a spark plug. The ignition circuit is suitable for use with any spark-ignited engine. Although this description is written in terms of spark ignitors for engines, there are other possible applications for spark ignitors, and the ignition circuit described herein could be used for those applications.

The ignition circuit is especially useful for spark-ignited internal combustion engines operating in a dilute combustion mode. In gasoline internal combustion engines, dilute combustion, using either air or re-circulated exhaust gas to dilute the gasoline, provides enhanced thermal efficiency and lowered NOx emissions. However, there is a limit at which an engine can be operated with a diluted mixture without causing undesired effects such as misfire and combustion instability. Therefore, various methods have been attempted to extend the dilution limit. These methods include improving ignitability of the mixture, increasing the flame speed, and operating the engine under controlled auto-ignition combustion. The system and method described below extend the dilution limit by increasing the spark duration.

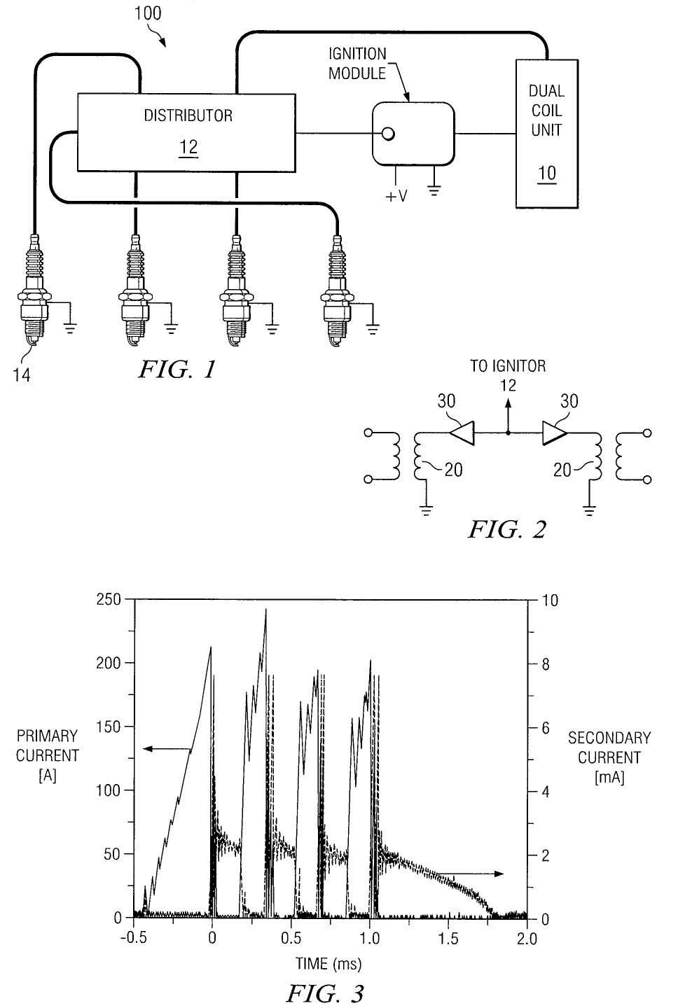

FIG. 1 illustrates one embodiment of a dual coil ignition circuit 100 in accordance with the invention. Circuit 100 is typical of an automobile ignition system or that of some other internal combustion engine, whose switching is performed using a mechanical system (distributor) 12. In other embodiments, the distributor may be implemented with solid state electronics. The battery or other electrical power source is represented as +V.

In a conventional engine, the ignition circuit would be a “single coil” ignition circuit, in which the coil has a primary ignition coil (winding), which induces a high voltage in a secondary coil (winding). More specifically, for each coil, current flows from the battery through the primary winding. The primary winding's current can be suddenly disrupted by breaker points, or by a solid-state device in an electronic ignition. When the circuit is suddenly broken, the magnetic field of the primary winding collapses rapidly. The secondary winding is engulfed by a powerful and changing magnetic field, which induces a high voltage to be delivered to an ignitor 14.

The circuit of FIG. 1, however, has a “dual coil” ignition circuit 100. As explained below in connection with FIGS. 2-5, a dual coil unit 10 has a pair of coils, operated in a dual strike mode in which their supply currents and their discharges are controlled such that their discharges are shortened and offset from each other.

The voltage from dual coil unit 10 is directed to spark plugs 14. For purposes of this description, spark plugs 14 may be generically referred to as “ignitors” to encompass sparking devices other than conventional spark plugs that may have been or may be developed.

In an alternative embodiment, dual coil ignition system 100 could be a “distributorless” ignition system. Advances in automotive ignition systems have led to a variety of ignition coil alternatives. Rather than using a single coil and distributing the spark voltage to a number of spark plugs, some engines eliminate the distributor and use a “coil on plug” design, in which each spark plug has its own coil. Each coil in this type of system works the same way as a larger, centrally-located coil. An engine control unit controls transistors that break the ground side of the circuit, which determines firing order and turns the coils on and off. For purposes of the present invention, in this type of ignition system, each conventional coil would be replaced with a dual coil unit 10.

Thus, the ignition system of FIG. 1 is but one example of various types of ignition systems, and other engines may have more than one dual coil unit 10. In general, regardless of the placement of, or number of dual coil units 10, the operation of each dual coil unit 10 is essentially the same. As described herein, each dual coil unit 10 has one or more associated ignitors, to which it delivers an ignition voltage.

Control unit 16 receives signals for controlling ignition timing as well as spark duration. It executes an ignition control algorithm in accordance with either of the strike modes described herein, and is implemented with appropriate processing and memory devices. It may be a stand-alone unit or integrated with other engine control processing devices and systems.

FIG. 2 illustrates the dual coil unit 10 in further detail. Dual coil unit 10 has two coils 20, each having its own primary and secondary winding. The coils 20 are connected to a common igniter 12 via diodes 30. The diodes 30 ensure that current can only flow into the associated ignitor 14 and not from one coil 20 to the other coil 20.

The dual coil unit 10 is used to extend the period in which a spark is at an igniter, such as in the gap of a spark plug 14. By extending this “spark event period”, one can improve the dilution tolerance of the engine and increase in-cylinder burn rates by improving the chances of ignition and helping the flame kernel interact more vigorously with the in-cylinder flow.

There are two potential methods for using dual coil unit 10 to achieve an extended duration spark. For both methods, coupling the long duration spark to in-cylinder flow improves burn rates and dilution tolerance.

Multi-Strike Mode

One method of using dual coil unit 10 is to use its coils in a multi-strike mode, where the primary voltage of the coils 20 is raised to a level that permits very rapid (<1 ms) primary coil charging. The voltage on the primary side can vary between 12 and 200 volts (or higher) depending on application and performance requirements.

After charging each coil 20 (via the primary winding), the discharge is allowed to occur (via induced current in the secondary winding). However, instead of fully discharging the coil 20, the discharge is only allowed to occur for ⅓ to ½ of its potential duration. Upon ending the discharge (by re-charging that coil), the other coil is partially discharged. Because the spark is most energetic and strongest during the first half of its life, this ensures that a high-quality spark is present for a considerable percentage of the time during the ignition event.

FIG. 3 is a current trace from the primary and secondary windings of a single coil 20, operated in a multi-strike firing event. FIG. 3 illustrates the current build in the primary winding each time the coil is charged. Current builds gradually in the primary, to a peak current. The vertical, downward lines to the right of each peak indicate that charge to the primary winding has been turned off, inducing a spark current in the secondary winding. Each of the four events energizes and then fires the coil to produce the multi-strike firing event.

As is further illustrated, the discharge of the primary winding is ended “early”, and its next charge is delayed. With two coils, each is run in the multi-strike mode but their discharges are offset from each other so that there is a continual spark present in the gap of the igniter for the duration of the ignition event.

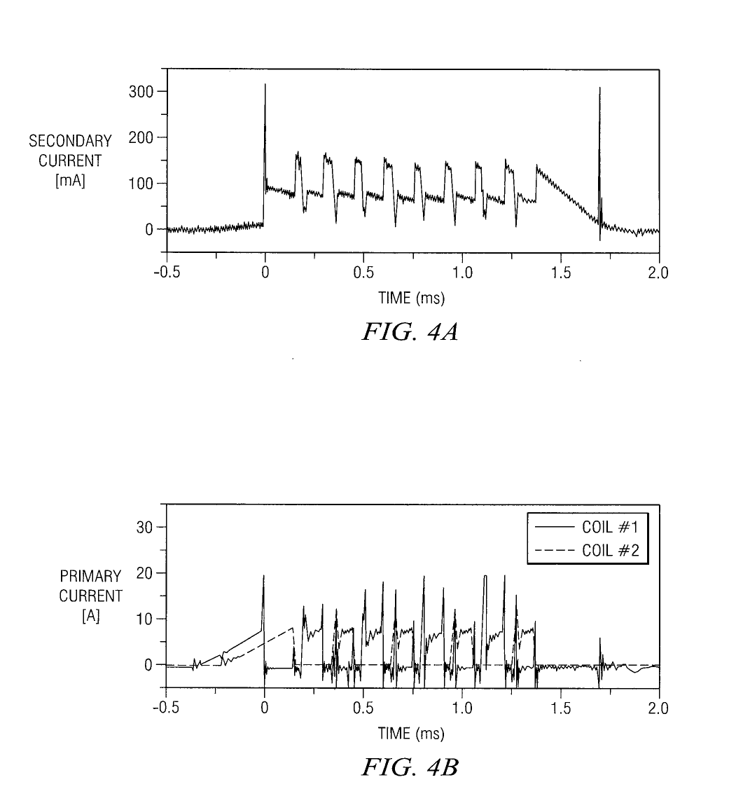

FIGS. 4A and 4B illustrate the primary and secondary currents of both coils 20, both operated in a multi-strike mode. FIG. 4A illustrates the secondary current as delivered to the common connection to the igniter. As illustrated, this current is continuous, relatively constant, and does not fall to zero.

In FIG. 4B, the primary currents are offset and alternating during the ignition event. The various spikes are noise.

The offset discharges from the two coils 20 significantly increases the amount of time the spark is in the gap, and by keeping the current relatively high, ensures a high quality spark in the gap the entire time. The result is an ignition event that is less sensitive to pressure effects than conventional single coil ignition circuits.

Although FIGS. 3, 4A, and 4B illustrate both coils having multiple discharges during the ignition event, it is also possible for the “multi-strike” mode to be performed such that each coil discharges once during the ignition event.

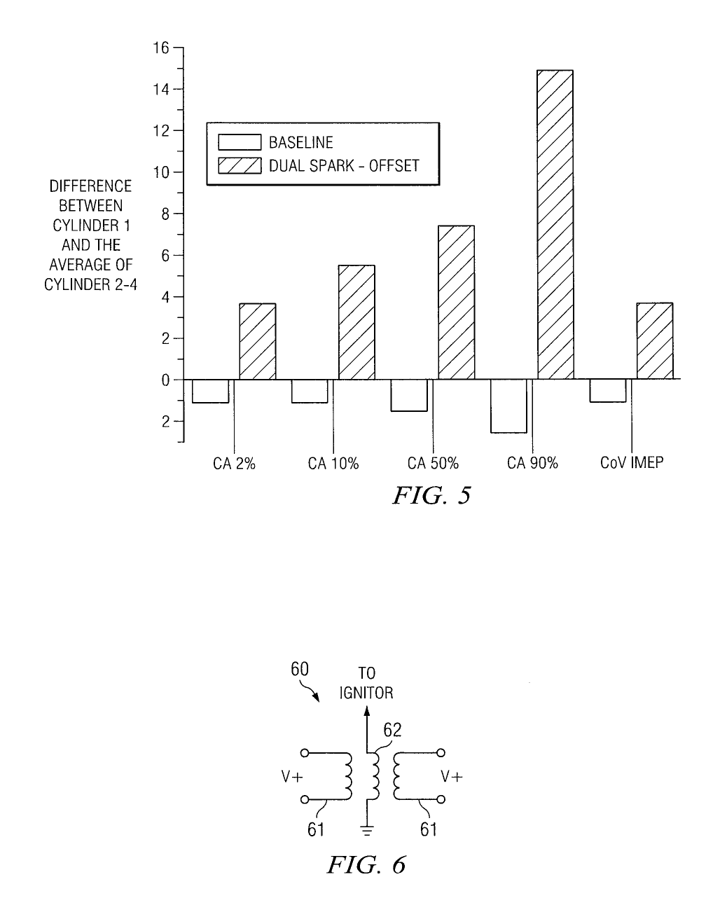

FIG. 5 illustrates how the burn rate of an engine is considerably improved as a result of a multi-strike mode of operation using dual coil unit 10. In this example, the engine is operated at 2000 rpm, with 20% EGR, and spark timing at 67 degrees before TDC.

CA is crank angle, and CoV is the coefficient of variance of the indicated mean effective pressure (a measure of how stable an engine is, that is, how repeatable the pressure trace is from cycle to cycle). Cylinder 1 was ignited with a dual coil unit, and the other cylinders were ignited with conventional sparks. As illustrated, the use of dual coil unit 10 with its increased spark duration thereby increases dilution tolerance and burn rates.

A further advantage of using dual coil unit 10 with offset discharges is that, since a spark is continually present in the gap, there is only one breakdown event, which reduces the amount of electronic noise produced during subsequent discharges, particularly at high cylinder pressures.

Single Strike Extended Duration Mode

Another method that can be used with the dual coil unit 10 does not involve multiple discharges or elevated primary voltages. Instead, one coil 20 is used to start the spark, and the other coil 20 is used to maintain it. The result is a high quality spark at the ignitor 14 for an extended time.

More specifically, the two coils 20 are organized such that the first coil is a “standard” automotive coil, which is capable of providing high secondary currents and very high voltages to initiate the spark. The second coil is a unique coil that acts more like a transformer than an ignition coil. This second coil has significantly more windings than the other to generate very high potential, but has a more limited peak current capacity. It allows current to flow continuously until it is turned off.

Once the first coil 20 establishes a spark, the second coil 20 is activated. The second coil 20 uses the high voltage relatively low current created to maintain the spark at the ignitor 14 until engine control unit 16 stops the discharge.

The single-strike mode of using dual coil unit 10 allows a spark to be maintained continuously while also serving to reduce much of the breakdown noise associated with a multi-strike ignition mode. Also, the control of this method is more simple, as each coil is turned on and off only once per ignition event. In addition, the requirements for increased primary voltage are relaxed, which reduces system cost.

Dual Coil with Shared Secondary Winding

FIG. 6 illustrates an alternative embodiment of the dual coil unit. In FIG. 6, dual coil unit 60 has two primary windings 61 and a shared secondary winding 62. The primary windings 61 are alternatingly charged in the same manner as the dual coil unit 20. However, the discharge is via the shared secondary winding 62, which is connected to the igniter. Dual coil unit 60 may be operated in either the multi-strike or single-strike modes discussed above.

What is claimed is:

1. A dual coil ignition circuit for providing an ignition voltage to an igniter during an ignition event, comprising:
at least one ignitor;
at least one dual coil unit having a first coil and a second coil, each coil having a primary winding and a secondary winding, wherein each primary winding is connected to a voltage source and each secondary winding delivers current induced by its associated primary winding to one or more igniters; and
a control unit for controlling the timing and duration of charging and discharging of the first coil and second coil, such that the discharge of the first coil is offset from the discharge of the second coil.

2. The ignition circuit of claim 1, wherein each coil is electrically connected to the ignitor via a diode.

3. The ignition circuit of claim 1, wherein each dual coil unit delivers current to multiple ignitors.

4. The ignition circuit of claim 1, wherein each dual coil unit delivers current to a single associated ignitor.

5. The ignition circuit of claim 1, wherein the primary coil and secondary coil have the same number windings.

6. The ignition circuit of claim 1, wherein the secondary coil has more windings than the primary coil.

7. The ignition circuit of claim 1, wherein the control unit further controls the discharge of each coil, such that each coil only partially discharges.

8. A multi-strike method of extending the duration of energy applied to an igniter during an ignition event, comprising:
connecting a dual coil unit to a voltage source and at least one igniter;
wherein the dual coil unit has a first coil and a second coil, each coil having a primary winding and a secondary winding, wherein each primary winding is connected to the voltage source and each secondary winding delivers current induced by its associated primary winding to the igniter; and
controlling the timing and duration of charging and discharging of the first coil and second coil, such that the discharge of the first coil is offset from the discharge of the second coil.

9. The method of claim 8, wherein the controlling step is further performed to control the discharge of each coil, such that each coil only partially discharges.

10. The method of claim 8, wherein each coil has one discharge during the ignition event.

11. The method of claim 8, wherein each coil has more than one discharge during the ignition event.

12. The method of claim 8, wherein each coil is electrically connected to the ignitor via a diode.

13. The method of claim 8, wherein each dual coil unit delivers current to multiple ignitors.

14. The method of claim 8, wherein each dual coil unit delivers current to a single associated ignitor.

15. A single strike method of extending the duration of energy applied to an igniter during an ignition event, comprising:
connecting a dual coil unit to a voltage source and at least one igniter;
wherein the dual coil unit has a first coil and a second coil, each coil having a primary winding and a secondary winding, wherein each primary winding is connected to the voltage source and each secondary winding delivers current induced by its associated primary winding to the igniter;
wherein the second coil has more windings than the first coil, such that it is operable as a transformer that discharges a higher voltage and lower current than the first coil; and
controlling the timing and duration of charging and discharging of the first coil and second coil, such that the discharge of the first coil is used to initiate the ignition event and discharge of the second coil is used to maintain current at the igniter during the ignition event.

16. The method of claim 15, wherein each coil is electrically connected to the ignitor via a diode.

17. The method of claim 15, wherein each dual coil unit delivers current to multiple ignitors.

18. The method of claim 15, wherein each dual coil unit delivers current to a single associated ignitor.

19. A dual coil ignition circuit for providing an ignition voltage to an igniter during an ignition event, comprising:
at least one ignitor;
at least one dual coil unit having a first coil and a second coil, each coil having a primary winding, each primary winding connected to a shared secondary winding, wherein each primary winding is connected to a voltage source and the secondary winding delivers current induced by the primary windings to one or more igniters; and
a control unit for controlling the timing and duration of charging of the primary windings and discharging of the secondary winding, such that the discharge induced by the one primary winding is offset from the discharge of the other primary winding.
